(19) United States
(12) Patent Application Publication
(10) Pub. No.: US 2002/0092137 A1
(43) Pub. Date: Jul. 18, 2002

(54) Leg-rope connection device

(76) Inventor: Brian Whitty, Warriewood (AU)

Correspondence Address: ROBERTS ABOKHAIR & MARDULA, SUITE 1000, 11800 SUNRISE VALLEY DRIVE, RESTON, VA, 20191, US

(21) Appl. No.: 10/057,356

(22) Filed: Jan. 25, 2002

(30) Foreign Application Priority Data
Jul. 26, 1999 (AU) PCT/AU00/00893
Jul. 26, 1999 (AU) PQ 1829

(51) Int. Cl. F16G 11/00

(52) U.S. Cl. 24/132 R

(57) ABSTRACT

A leg-rope connection device (1) includes a leg-rope guide (7) formed within a housing (2), a first arm member (3) operatively associated with the housing (2) and able to be rotated about a first hinge (5) and a second arm member (4) operatively associated with the housing (2) and able to be rotated about a second hinge (6). First clamping means (17) is associated with the first arm member (3) for retaining a first portion of a leg-rope within the leg-rope guide (7) and second clamping means (18) is associated with the second arm member (4) for retaining a second portion of a leg-rope within the leg-rope guide (7). Method of repairing a broken leg-rope using said leg-rope connection device (1) is also disclosed.

### TECHNICAL FIELD

The present invention relates to a leg-rope connection device, and in particular, to a surfboard leg-rope connection device which can be used in a variety of environments, for example in the ocean or on land.

If the urethane rubber of a surfer's leg-rope is broken then the leg-rope connection device can be utilised to rejoin the broken urethane rubber portions whilst the surfer remains in the water if so desired.

### BACKGROUND ART

A leg-rope is a device often used when riding a surfboard. The leg-rope is attached to a surfer's leg via a neophrene velcro strap or similar material at one end of the leg-rope, and to the surfboard via a velcro strap or similar at the other end of the leg-rope. Thus, the leg-rope causes the surfboard to remain within the vicinity of the surfer if the surfer falls from the surfboard. It is desirable that the surfboard remain within the vicinity of the surfer for the safety of the surfer, and to prevent the surfer having to chase the surfboard by swimming. Additionally, a leg-rope prevents the surfboard travelling to the beach or onto rocks or reef which may result in the surfboard being damaged.

A leg-rope is typically manufactured from a long cylindrical strip of urethane rubber approximately 6 to 8 mm in diameter and 2 m in length with the velcro/neophrene straps disposed at the ends. When a surfer falls from a surfboard substantial forces may be applied to the urethane rubber cylindrical strip as water movement in the ocean acts to pull the surfboard away from the surfer or vice versa. This can result in the urethane rubber cylindrical strip being snapped. Furthermore, various other situations encountered whilst surfing may result in or require the urethane rubber strip to be broken or cut.

Presently, if the urethane rubber strip of the leg-rope is snapped, broken or cut, the leg-rope is rendered useless as a surfboard retaining aid. The surfer must then exit the ocean to obtain a replacement. In many cases this can be difficult when surfing at remote locations such as outside ocean reefs or rocky points. At present, there is no known method of repairing or joining the urethane rubber strip of the leg-rope whilst remaining in the ocean.

This identifies a need for a leg-rope connection device capable of being utilised by a surfer without requiring the surfer to exit the ocean.

### SUMMARY OF THE INVENTION

The present invention seeks to provide a device which can be carried by a surfer whilst surfing and may be used to rejoin a leg-rope in the event that the surfer's leg-rope is snapped.

The present invention further seeks to provide a device which can be carried by a surfer whilst surfing and may be used to rejoin a leg-rope in the event that the surfer's leg-rope is snapped, in addition to providing means for the adjustment or operation of various mechanisms associated with a surfboard, for example surfboard fin retention mechanisms.

The present invention according to one aspect provides a leg-rope connection device including a housing which encloses a portion of the leg-rope, and at least one clamping member operatively associated with the housing, whereby said clamping member associates with the leg-rope in a manner such that said portion of the leg-rope is retained within the housing when subjected to typical forces applied to the leg-rope when in use.

In a preferred embodiment of the present invention there are two clamping members.

In a further preferred embodiment of the present invention clamping members are rotatable with respect to the housing.

In still a further preferred embodiment of the present invention the device is additionally provided with at least one tool member.

In a preferred embodiment the present invention seels to provide a leg-rope connection device including:

a leg-rope guide integrally formed within a housing;

a first arm member operatively associated with the housing, said first arm member able to be rotated about a first hinge;

a second arm member operatively associated with the housing, said second arm member able to be rotated about a second hinge;

first clamping means associated with the first arm member for retaining a first portion of a leg-rope within the leg-rope guide; and

second clamping means associated with the second arm member for retaining a second portion of the leg-rope within the leg-rope guide.

Preferably, the leg-rope guide is substantially semi-circular in cross-section.

Also preferably, the first clamping means are integrally formed as part of the first arm member and the second clamping means are integrally formed as part of the second arm member.

In a further embodiment of the present invention the first clamping means and the second clamping means are at least partly contained on the internal surface of the leg-rope guide.

In yet a further preferred form of the present invention the first arm member and the second arm member are identical but disposed at opposite ends of the housing.

In yet a further preferred form of the present invention the first clamping means are at least one cleat, hump, tenon, lip, protrusion, sawtooth, wedge, angled surface, incline, pin, tapered member, spike, serration or the like which act to compress the first portion of the leg-rope when the first arm member is closed

In still yet a further preferred form of the present invention the second clamping means are at least one cleat, hump, tenon, lip, protrusion, sawtooth, wedge, angled surface, incline, pin, tapered member, spike, serration or the like which act to compress the second portion of the leg-rope when the second arm member is closed.

Broadly, in a particular embodiment of the present invention the first hinge and/or the second hinge mechanism is a pin or protrusion, and, hole or recess arrangement.

In a further preferred form of the present invention the first arm member holds a first tool member.

In yet a further preferred form of the present invention the second arm member holds a second tool member.

In still yet a further preferred form of the present invention either of the tool members is interchangeable with an alternate tool member.

According to one aspect of the present invention the tool member is a screwdriver, alan-key or blade or the like.

In a particular embodiment of the present invention at least part of the device is manufactured from a rigid polymeric material.

In a further embodiment of the present invention any of the surfaces of the device can be provided with a textured, roughened, teethed, jagged, serrated or similar surface.

The present invention further seeks to provide a method of repairing a broken leg-rope, including the steps of:

providing a leg-rope connection device;

inserting a first portion of the broken leg-rope into a first end of the leg-rope connection device;

inserting a second portion of the broken leg-rope into a second end of the leg-rope connection device;

closing a first clamping member operatively associated with a housing of the leg-rope connection device, whereby said first clamping member associates with the first portion of the broken leg-rope in a manner such that said first portion of the broken leg-rope is retained within the housing; and

closing a second clamping member operatively associated with the housing of the leg-rope connection device, whereby said second clamping member associates with the second portion of the broken leg-rope in a manner such that said second portion of the broken leg-rope is retained within the housing.

In another preferred form of the invention there is provided a leg-rope connection device, substantially according to the embodiments contained within the specification with reference to and as illustrated in the accompanying figures.

In another preferred form of the invention there is provided a method for repairing a broken leg-rope, substantially according to the embodiments contained within the specification with reference to the accompanying figures.

### BRIEF DESCRIPTION OF THE DRAWINGS

The present invention will become better understood from the following detailed description of preferred but non-limiting embodiments thereof, described in connection with the accompanying drawings, wherein:

FIG. 1 illustrates a preferred embodiment of the present invention wherein, the figure shows a perspective view of the leg-rope connection device.

FIG. 2 illustrates a preferred embodiment of the present invention wherein, the figure shows a rotated perspective view of the leg-rope connection device.

FIG. 3 illustrates a preferred embodiment of the present invention wherein, the figure shows a top view of the leg-rope connection device.

FIG. 4 illustrates a preferred embodiment of the present invention wherein, the figure shows a cross-sectional view of the leg-rope connection device.

FIG. 5 illustrates a preferred embodiment of the present invention wherein, the figure shows an end view of the leg-rope connection device.

FIG. 6 illustrates a preferred embodiment of the present invention wherein, the figure shows a representation of the leg-rope connection device with one swing member open.

FIG. 7 illustrates a preferred embodiment of the present invention wherein, the figure shows a representation of the leg-rope connection device with one swing member open and the leg-rope portions inserted.

### MODES FOR CARRYING OUT THE INVENTION

The present invention provides a leg-rope connection device. In the figures, incorporated to illustrate the features of the present invention, like reference numerals are used to identify like parts throughout the figures.

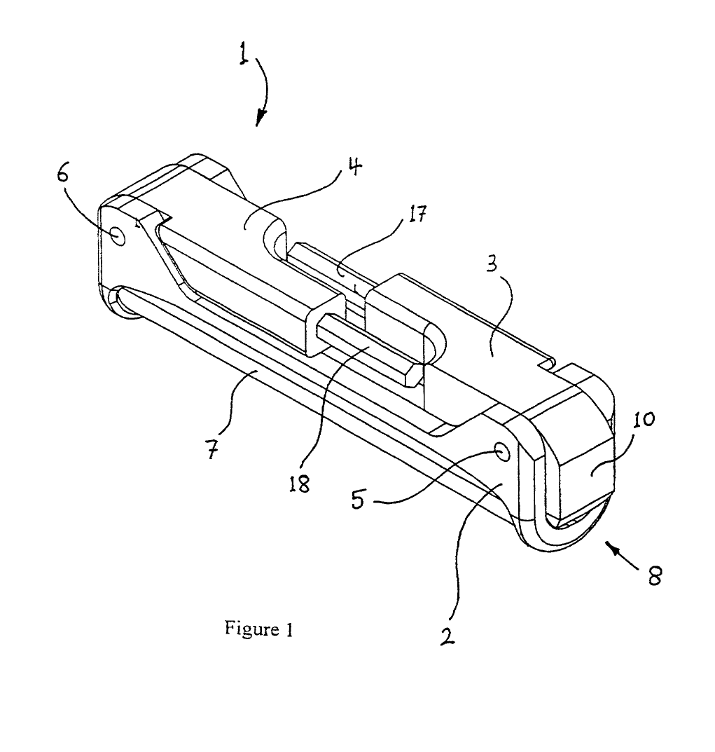

A preferred, but non-limiting, embodiment of the present invention is shown in FIG. 1. In the figure the leg-rope connection device 1 includes a housing 2 which is adapted to receive a first arm member 3 and a second arm member 4. Said arm members could alternatively be described as swing cleat members. A first hinge 5 associates the first arm member 3 with the housing 2 in a manner whereby the first arm member 3 can rotate about the axis of the first hinge 5. Similarly, a second hinge 6 associates the second arm member 4 with the housing 2 in a manner whereby the second arm member 4 can rotate about the axis of the second hinge 6. The first hinge 5 and the second hinge 6 can be provided as pins or the like which are received by orifices, holes or bores in the housing 2 and the arm members 3 and 4. Alternatively, the arm members 3 and 4 can be provided with lateral cylindrical protrusions, said lateral cylindrical protrusions being received by orifices, holes, bores or recesses in appropriate positions in the housing 2. Numerous other mechanisms providing for the arm members 3 and 4 to be in rotational association with the housing 2 can be provided to work the present invention.

Integrally formed as part of the housing 2 is a leg-rope guide 7. The leg-rope guide 7 receives a first broken portion of a leg-rope 11 via a first leg-rope orifice 8, and a second broken portion of a leg-rope 12 via a second leg-rope orifice 9. Before the portions of broken leg-rope 11 and 12 can be inserted into the leg-rope orifices 8 and 9 said orifices must be exposed by rotating be first arm member 3 and the second arm member 4 into open positions.

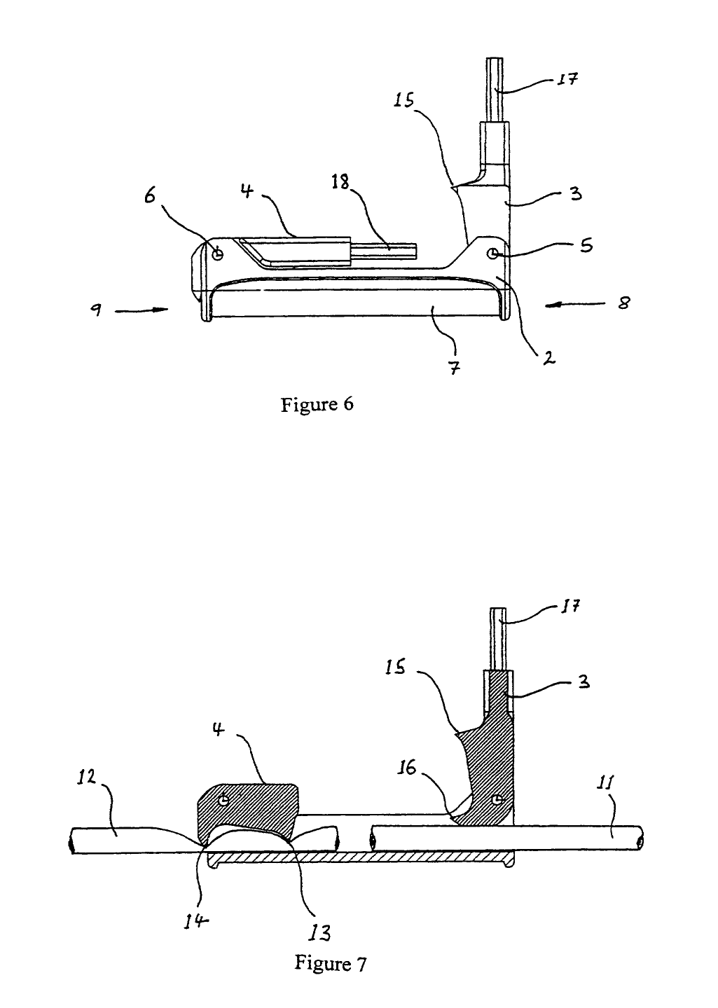

By lifting the first arm member 3 away from the housing 2 the first arm member 3 is caused to rotate about the axis of the first hinge 5. This action causes the first arm member occlusion 10 to swing into the first leg-rope orifice 8. When the first arm member 3 is in an open position, as illustrated in FIG. 6, then the first leg-rope orifice 8 is fully exposed and a first broken portion of a leg-rope 11 may be inserted into the leg-rope guide 7 via the first leg-rope orifice 8. This is further illustrated in FIG. 7. In FIGS. 6 and 7, the first arm member 3 is highlighted and presented unobscured by the housing 2 for the purposes of illustration.

This process can then be repeated for the second arm member 4 so that a second broken portion of a leg-rope 12 can be inserted into the leg-rope guide 7 from the opposing end, that is the second leg-rope orifice 9. With reference to FIG. 7, once a broken portion of leg-rope has been inserted into the leg-rope guide 7, the corresponding arm member is then closed upon the inserted broken portion of leg-rope. This has the effect of clamping the inserted broken portion of leg-rope within the leg-rope guide 7/housing 2.

In a preferred embodiment, the second arm member 4 is provided with an inner second arm cleat 13 or similar clamping member and an outer second arm cleat 14 which are adapted to clamp the inserted broken portion of leg-rope 12 against the inner surface of the leg-rope guide 7, thereby preventing be inserted broken portion of leg-rope 12 from being removed from the leg-rope guide 7/housing 2 when the broken portion of leg-rope 12 is subjected to forces attempting to separate the broken portions of leg-rope 12 and 11. Similarly, the first arm member 3 is provided with an inner first arm cleat 15 or similar clamping member and an outer first arm cleat 16 which are adapted to clamp the inserted broken portion of leg-rope 11 against the inner surface of the leg-rope guide 7.

When the broken portions of leg-rope 11 and 12 have been appropriately inserted into the leg-rope guide 7 and the arm members 3 and 4 have subsequently been closed, then the broken portions of leg-rope 11 and 12 are fixedly held in proximity to each other. Hence, a surfboard will be held in proximity to a surfer with the aid of the leg-rope connection device 1 even though the leg-rope has been broken.

It should be noted that although cleats 13, 14, 15 and 16 have been described in a preferred embodiment for clamping broken portions of leg-rope 11 and 12 within the leg-rope guide 7/housing 2, numerous other retaining or clamping mechanisms could be used. For example, the cleats may be provided as or with humps, tenons, lips, protrusions, sawteeth, wedges, angled surfaces, inclines, pins, tapered members, spikes, serrations or any other similar type of device/s. Additionally, the location and number of cleats can be varied. For example, each arm member may be provided with any number of cleats, and/or the inner surface of the leg-rope guide 7 may also be provided with any number of cleats or similar features as identified herein.

The internal surface of the housing of any of the embodiments of the present invention may additionally be provided with a textured, roughened, teethed, jagged, serrated or like surface thereby improving the retention of the broken portions of the leg-rope 11 and 12 within the housing.

In a preferred embodiment of the present invention the first arm member 3 can be provided with a first tool member 17 and/or the second arm member 4 can be provided with a second tool member 18. As illustrated in the figures, said tool members 17 and 18 are provided on the ends of the arm members 3 and 4 respectively, and are adapted to be received within the leg-rope connection device 1 when the said arm members 3 and 4 are in a closed position.

It should be noted that tool members 17 and 18 can be provided as interchangeable tool members, that is, the tool members 17 and 18 can be provided with a mechanism which fixedly associates each tool member with an arm member but allows the tool member to be exchanged for another tool member. As a non-limiting example this could be achieved by providing the tool member with a thread which can be received by a threaded orifice or hole integrally formed within an arm member. Either zero, one, two or more tool members can be provided with the leg-rope connection device 1.

The tool members 17 and 18 are illustrated as alan-keys, however, each tool member could be provided as any other type of tool. For example, at least one tool member could be provided as a screw driver or blade. Generally, any type of tool which could be of use to a surfer can be provided.

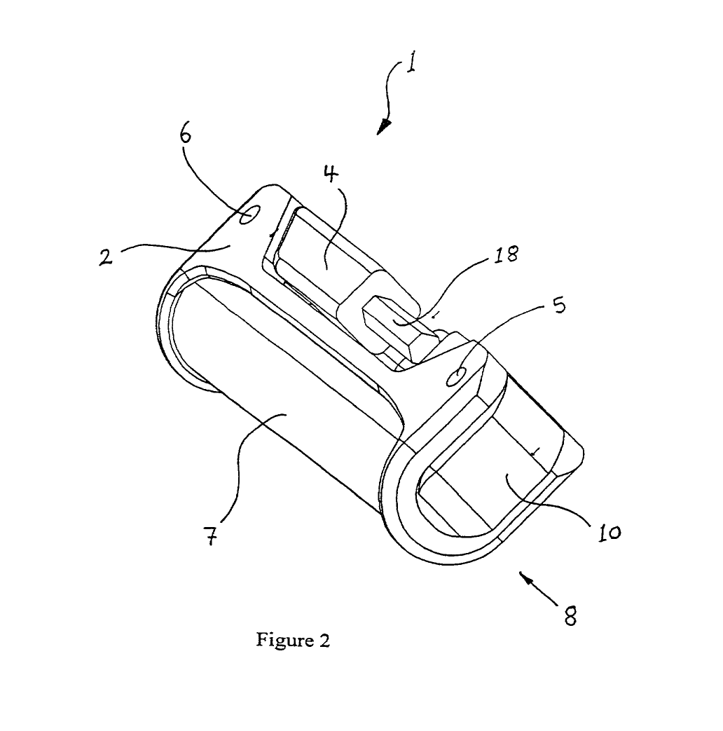

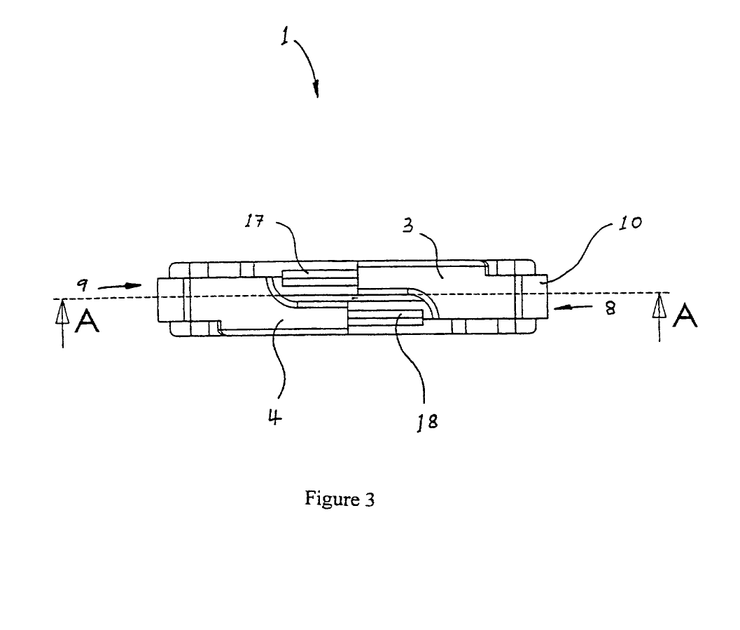

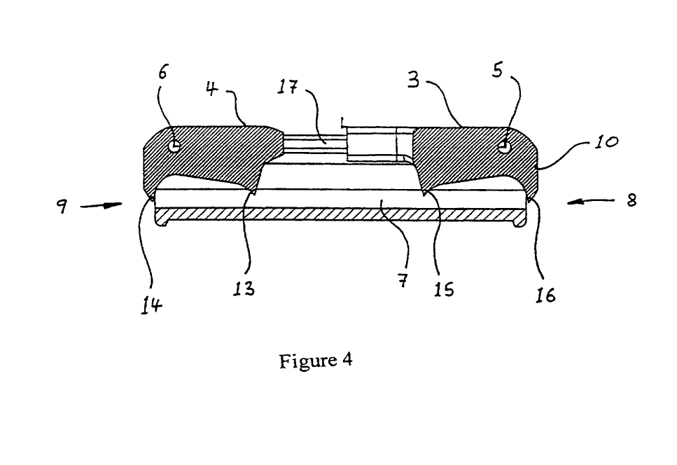

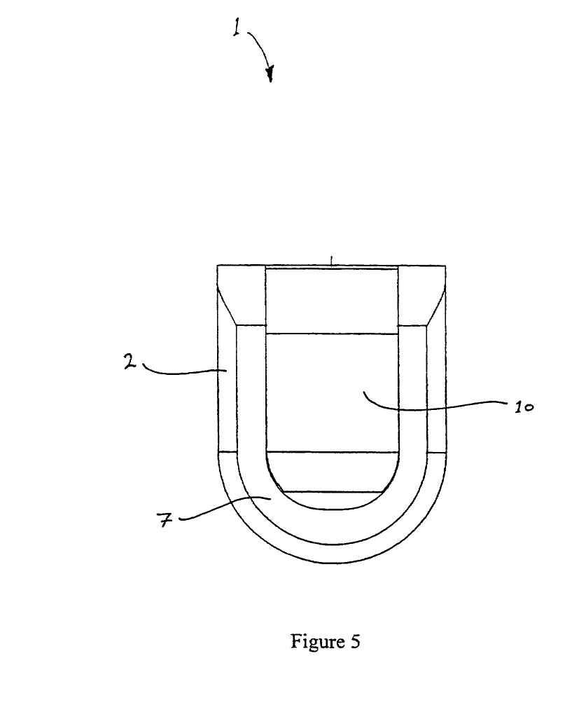

Shown in FIG. 2 is a rotated view of the leg-rope connection device 1. Shown in FIG. 3 is a top-view of the leg-rope connection device 1, also a cross-sectional line A-A is defined. In FIG. 4 is shown a cross-section of the leg-rope connection device 1 along the line A-A. In FIG. 5 an end view of the leg-rope connection device 1 is illustrated.

Hence, not only can a surfer use and operate the leg-rope connection device 1 whilst remaining in the ocean, the leg-rope connection device 1 can be further provided with tool members 17 and/or 18 which may be of use to a surfer, for example to reattach or replace surfboard fins.

Any of the embodiments of the present invention may be manufactured from a variety of materials, for example, the housing or any other component of the leg-rope connection device 1 may be manufactured from a rigid polymeric material, metal, natural material or any other material. The present invention is not limited to manufacture from a single material but may be comprised of numerous materials which provide a sufficient degree of clamping of the leg-rope connection device 1 to the urethane rubber of the leg-rope.

Furthermore, the exterior surface of the leg-rope connection device may be of a shape which aids in reducing the frictional drag on the connection device while moving in the water.

Thus, there has been provided in accordance with the present invention, a leg-rope connection device which satisfies the advantages set forth above and overcomes the problems hereinbefore discussed.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

The reference to any prior art in this specification is not, and should not be taken as, an acknowledgment or any form of suggestion that that prior art forms part of the common general knowledge in Australia.

Although the preferred embodiment has been described in detail, it should be understood that various changes, substitutions, and alterations can be made herein by one of ordinary skill in the art without departing from the scope of the present invention as hereinbefore described and as hereinafter claimed.

Various alternate embodiments of the present invention have been proposed by the Applicant in the document AU PQ1829/99, all disclosures therein are within the scope of the present invention and are to be considered as disclosed herein.

The claims:

1. A leg-rope connection device including a housing which encloses a portion of the leg-rope, and at least one clamping member operatively associated with the housing, whereby said clamping member associates with the leg-rope in a manner such that said portion of the leg-rope is retained within the housing when subjected to typical forces applied to the leg-rope when in use.

2. A leg-rope connection device as claimed in claim 1, wherein there are two clamping members.

3. A leg-rope connection device as claimed in either claim 1 or claim 2, wherein clamping members are rotatable with respect to the housing.

4. A leg-rope connection device as claimed in any one of the claims 1 to 3, wherein the device is additionally provided with at least one tool member.

5. A leg-rope connection device including:
a leg-rope guide integrally formed within a housing;
a first arm member operatively associated with the housing, said first arm member able to be rotated about a first hinge;
a second arm member operatively associated with the housing, said second arm member able to be rotated about a second hinge;
first clamping means associated with the first arm member for retaining a first portion of a leg-rope within the leg-rope guide; and
second clamping means associated with the second arm member for retaining a second portion of the leg-rope within the leg-rope guide.

6. A leg-rope connection device as claimed in claim 5, wherein the leg-rope guide is substantially semi-circular in cross-section.

7. A leg-rope connection device as claimed in either claim 5 or claim 6, wherein the first clamping means are integrally formed as part of the first arm member and the second clamping means are integrally formed as part of the second arm member.

8. A leg-rope connection device as claimed in any one of the claims 5 to 7, wherein the first clamping means and the second clamping means are at least partly contained on the internal surface of the leg-rope guide.

9. A leg-rope connection device as claimed in any one of the claims 5 to 8, wherein the first arm member and the second arm member are identical but disposed at opposite ends of the housing.

10. A leg-rope connection device as claimed in any one of the claims 5 to 9, wherein the first clamping means are at least one cleat, hump, tenon, lip, protrusion, sawtooth, wedge, angled surface, incline, pin, tapered member, spike, serration or the like which act to compress the first portion of the leg-rope when the first arm member is closed.

11. A leg-rope connection device as claimed in any one of the claims 5 to 10, wherein the second clamping means are at least one cleat, hump, tenon, lip, protrusion, sawtooth, wedge, angled surface, incline, pin, tapered member, spike, serration or the like which act to compress the second portion of the leg-rope when the second arm member is closed.

12. A leg-rope connection device as claimed in any one of the claims 5 to 11, wherein the first hinge and/or the second hinge mechanism is a pin or protrusion, and, hole or recess arrangement.

13. A leg-rope connection device as claimed in any one of the claims 5 to 12, wherein the first arm member holds a first tool member.

14. A leg-rope connection device as claimed in any one of the claims 5 to 13, wherein the second arm member holds a second tool member.

15. A leg-rope connection device as claimed in either claim 13 or claim 14, wherein either of the tool members is interchangeable with an alternate tool member.

16. A leg-rope connection device as claimed in any one of the claims 5 to 15, wherein the tool member is a screwdriver, alan-key or blade.

17. A leg-rope connection device as claimed in any one of the claims 5 to 16, wherein at least part of the device is manufactured from a rigid polymeric material.

18. A leg-rope connection device as claimed in any one of the claims 5 to 17, wherein any of the surfaces of the device can be provided with a textured, roughened, teethed, jagged, serrated or similar surface.

19. A method of repairing a broken leg-rope, including the steps of:
providing a leg-rope connection device;
inserting a first portion of the broken leg-rope into a first end of the leg-rope connection device;
inserting a second portion of the broken leg-rope into a second end of the leg-rope connection device;
closing a first clamping member operatively associated with a housing of the leg-rope connection device, whereby said first clamping member associates with the first portion of the broken leg-rope in a manner such that said first portion of the broken leg-rope is retained within the housing; and
closing a second clamping member operatively associated with the housing of the leg-rope connection device, whereby said second clamping member associates with the second portion of the broken leg-rope in a manner such that said second portion of the broken leg-rope is retained within the housing.

20. A leg-rope connection device, substantially according to the embodiments contained within the specification with reference to and as illustrated in the accompanying figures.

21. A method of repairing a broken leg-rope, substantially according to the embodiments contained within the specification with reference to the accompanying figures.
